(19) United States
(12) Patent Application Publication
(10) Pub. No.: US 2008/0285927 A1
(43) Pub. Date: Nov. 20, 2008

(54) Single Mode Optical Fiber Having Reduced Macrobending and Attenuation Loss and Method for Manufacturing the Same

(75) Inventors: Amjad Khan, Maharashtra (IN); Sanket Shah, Maharashtra (IN); Jegan Miras, Tamil Nadu (IN)

Correspondence Address: LADAS & PARRY LLP, 224 SOUTH MICHIGAN AVENUE, SUITE 1600, CHICAGO, IL, 60604, US

(73) Assignee: STERLITE OPTICAL TECHNOLOGIES LTD., Aurangabad (IN)

(21) Appl. No.: 11/814,216

(22) PCT Filed: Apr. 20, 2007
(86) PCT No.: PCT/IN07/00153

§ 371 Date: Jul. 18, 2007

(30) Foreign Application Priority Data
Apr. 24, 2006 (IN) 642/MUM/2006

(51) Int. Cl. G02B 6/02; C03B 37/012

(52) U.S. Cl. 385/123; 65/426; 65/424; 65/414

(57) ABSTRACT

A method for manufacturing an optical fiber having uniform refractive index profile, and substantially reduced macrobending loss and attenuation loss is provided comprising controlling one or more of parameters including concentration of dopant in outer region and inner region of the core region with respect to middle region of the core region of the optical fiber preform, duration of dehydration process step, concentration of chlorine gas to control refractive index of outer region and inner region of the core region for achieving a fiber having substantially uniform refractive index profile, and substantially reduced macrobending loss and attenuation loss.

### FIELD OF THE INVENTION

The present invention generally relates to optical fiber having reduced bending loss and attenuation loss. Particularly, the present invention relates to single mode optical fiber having reduced macrobending loss and attenuation loss. More particularly, it relates to single mode optical fiber having reduced macrobending loss and attenuation loss, and being suitable for access communication network applications. The present invention also relates to a method for manufacturing single mode optical fiber having reduced macrobending loss and attenuation loss, and being suitable for access communication network applications.

### BACKGROUND OF THE INVENTION

Optical fibers are inherently versatile as a transmission medium for all forms of information, be it voice, video or data. Optical fiber comprises a core, to which essentially the entire signal is confined, and a clad surrounding the core. The optical fiber is manufactured in a way to have core with higher refractive index with respect to the refractive index of cladding in order to achieve light transmission inside the core region. The optical power also spreads in the cladding region near the core region.

Conventionally, the single mode optical fibers having zero dispersion near wavelength of about 1310 nm have been used in the wavelength region varying from about 1310 nm to about 1550 nm. The optical fibers for telecommunications are required to operate with the lowest attenuation loss at a wavelength of about 1550 nm. As the requirement for optical performance of optical fibers is stringent, the source of attenuation loss in optical fiber needs to be eliminated at a wavelength of about 1550 nm. However, certain physical constraints in which the optical fibers can be used result in increase in attenuation loss of the fiber and an important one of these physical constraints is bending loss of the fiber, which is introduced during bending of the fiber while transporting and installation. Therefore, if bending loss of a fiber increases it results in increase in the attenuation loss of the fiber.

In an optical fiber produced by conventional method, the signal losses of substantial level may be introduced either by turning the fiber about a point with relatively smaller radius of curvature, or by waviness introduced during sheathing of the fiber or some other mechanical factors. It has been observed that a planar wavefront, which must propagate through a bend, has different path lengths between the center of the core and its outer radius. A shift in mode field diameter of fiber on its bending 115 has been observed to result in energy losses thereby resulting in increase in bending loss of the fiber [FIG. 1]. These losses are known as macrobending losses and have been found to be dependent upon the extent of the bending that is introduced in the fiber. If radius of curvature of the bend of the optical fiber is smaller and wavelength of transmitted light is longer, the macrobending loss in optical fiber has been observed to increase. Further, the macrobending loss caused by loss of power due to radiation at bend has been observed to increase exponentially with decrease in the radius of bending of the optical fiber. It has been observed that below a critical radius of optical fiber bending, the macrobending loss in the optical fiber becomes significant and noticeable.

Typically a fiber is produced from a fiber preform which can be manufactured, for example by an Atmospheric Chemical Vapour Deposition [ACVD] method [FIG. 2], wherein the glass soot is deposited on the cylindrical member (target rod) 101 loaded on a deposition lathe 102 between the chucks 103 and 104 over one or more of soot forming burners 105 placed at close proximity to each other, to form soot porous body 100, wherein the deposition is accomplished by rotation (indicated by arrow 111) and traverse motion, in the direction shown by an arrow 110, of the target rod 101 over the burners 105 or vice versa. The whole setup, that is, the burners) 105, the cylindrical member 101 loaded on the deposition lathe 102 and the deposition lathe 102 are enclosed in side a chamber 106. An exhaust duct 108 to remove the soot not deposited on the cylindrical member and other reaction products is provided over in the chamber 106. The initial soot deposition comprises dopant chemicals [for example GeO₂] to increase refractive index of the core region and the dopant chemicals are then terminated after deposition of desired core diameter. The deposition process is continued until the soot porous body 100 having desired core-clad diameter ratio is produced. The cylindrical member 101 is detached from the soot porous body 100 to form hollow cylindrical soot porous body (herein after referred as hollow soot porous body). The word “hollow” is used to indicate that after the cylindrical member 101 is detached, the cylindrical soot porous body has a hole running along its length. This hole is also referred to as capillary. The hollow soot porous body is then moved into a sintering furnace, wherein the hollow soot porous body is dehydrated at a temperature of about 900° C. to 1200° C., in an atmosphere of dehydrating gases such as chlorine and gases having high thermal conductivity such as helium. The dehydration is carried out for a duration sufficient to achieve reduced hydroxyl content in the hollow soot porous body. Thereafter, the dehydrated hollow soot porous body is sintered (also known as vitrification or consolidation) and the capillary is collapsed simultaneously in the sintering in a chlorine and helium atmosphere to form optical fiber preform (also called mother preform) at about 1500° C. to 1600° C. temperature. Optical fiber can be directly drawn from the mother preform or the mother preform is drawn into rods (also known as core rod), of lower diameter as compared to mother preform. The core rods are overcladded with extra cladding layer to form a soot porous body having overcladding in a deposition lathe similar to 102. Thereafter, the soot porous body having overcladding is moved into a sintering furnace provided with supply of dehydration gas such as chlorine and high thermal conductivity gas such as helium to form a sintered preform (also known as daughter preform), which is subjected to a step of drawing to draw the optical fiber.

The refractive index profile analysis of the core region of the optical fiber preform (the mother preform may also be referred as optical fiber preform or preform) or core rods drawn therefrom or optical fiber produced from such optical fiber preform or core rods reveals that it has slope 116 in the refractive index of outer region of the core region of the optical fiber preform or core rod, and a sudden dip 117 in the refractive index of central region of the core region of the optical fiber preform or core rod or optical fiber, that is it has non-uniform refractive index in outer region and central region of the core region of the optical fiber preform or core rod or optical fiber [FIG. 3].

The non-uniform refractive index, e.g. formation of slope 116 in refractive index of outer region of the core region of the optical fiber preform or core rod or optical fiber produced from such optical fiber preform or core rods, and sudden dip 117 in the refractive index of central region of the core region of the optical fiber preform or core rod or optical fiber produced from such optical fiber preform or core rods, have been observed to result in increase in macrobending loss in drawn optical fiber, thereby make the optical fiber unsuitable for access communication network applications.

The increase in macrobending loss of the drawn optical fiber has been observed to result in increase in loss of power from the input to output of the optical fiber which results in increase in attenuation loss of the optical fiber, and hence, renders the optical fiber unsuitable for access communication network applications.

The attenuation loss has been observed to increase further when optical fiber is bended or wounded on a medium.

### NEED OF THE INVENTION

Therefore, there is a need to have a method for manufacturing optical fiber having reduced macrobending loss and attenuation loss, thereby making the fiber suitable for access communication network applications.

There is also a need to have optical fiber having reduced macrobending loss and attenuation loss, thereby being suitable for access communication network applications.

Therefore, there is also a need to have a method for manufacturing optical fiber preform or core rods having substantially uniform refractive index profile, that is having substantially reduced slope and sudden dip in its refractive profile, and therefore, being suitable for producing optical fiber having substantially reduced macrobending loss and attenuation loss.

### OBJECTS OF THE INVENTION

The main object of the present invention is to have a method for manufacturing optical fiber having reduced macrobending loss and attenuation loss, thereby making the fiber suitable for access communication network applications.

The another object of the present invention is to have an optical fiber having reduced macrobending loss and attenuation loss, thereby being suitable for access communication network applications.

Still another object of the present invention is to have a method for manufacturing optical fiber preform or core rods having substantially uniform refractive index profile, that is having substantially reduced slope and sudden dip in its refractive profile, and therefore, being suitable for producing optical fiber having substantially uniform refractive index profile, that is having substantially reduced slope and sudden dip in its refractive profile, and hence, having substantially reduced macrobending loss and attenuation loss.

Yet another object of the present invention is to have optical fiber preform or core rods having substantially uniform refractive index profile, that is having substantially reduced slope and sudden dip in its refractive profile.

This is also an object of the present invention to have an optical fiber having substantially uniform refractive index profile, that is having substantially reduced slope and sudden dip in its refractive profile.

This is also an object of the present invention to have an optical fiber having bending loss less than about 0.05 dB/Km at a wavelength of about 1550 nm.

This is also an object of the present invention to have an optical fiber having bending loss less than about 0.05 dB/Km at a wavelength of about 1550 nm even when fiber is turned-on.

This is also an object of the present invention to have an optical fiber wherein attenuation loss is less than about 0.30 dB/Km at about 1383 nm, about 0.34 dB/Km at about 1310 nm and about 0.19 dB/Km at about 1550 nm.

This is also an object of the present invention to have an optical fiber not only having reduced macrobending loss and attenuation loss, but simultaneously also having other characteristics within the desired limits.

The other objects and advantages of the present will be apparent from the following description when read in conjunction with the accompanying drawings and examples which are incorporated for illustration of preferred embodiments of the present invention and are not intended to limit scope thereof.

### BRIEF DESCRIPTION OF THE ACCOMPANYING FIGURES

FIG. 1 shows mode field distributions inside the optical fiber when light transmits from a straight portion to the bend portion of the fiber.

FIG. 2 is a schematic representation of a conventional apparatus for soot deposition process on a cylindrical member to form an optical fiber preform (mother preform).

FIG. 3 shows refractive index profile having central dip towards the central region and slope towards the outer region of the core region of optical fiber preform or core rod or optical fiber manufactured in accordance with the conventional method.

FIG. 4 shows cross sectional view of the ideal step index single mode optical fiber comprising core region and clad region, and refractive index profile thereof.

FIG. 5 shows refractive index profiles having no or substantially reduced central dip towards the central region and no or substantially reduced slope towards the outer region of the core region of optical fiber preform or core rod or optical fiber manufactured in accordance with certain embodiments of the present invention.

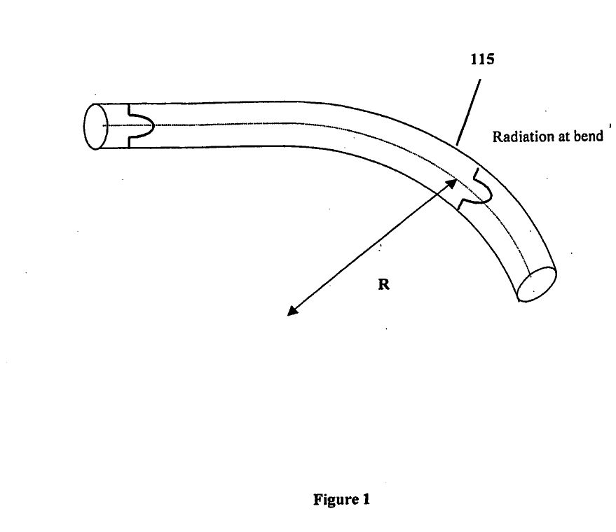

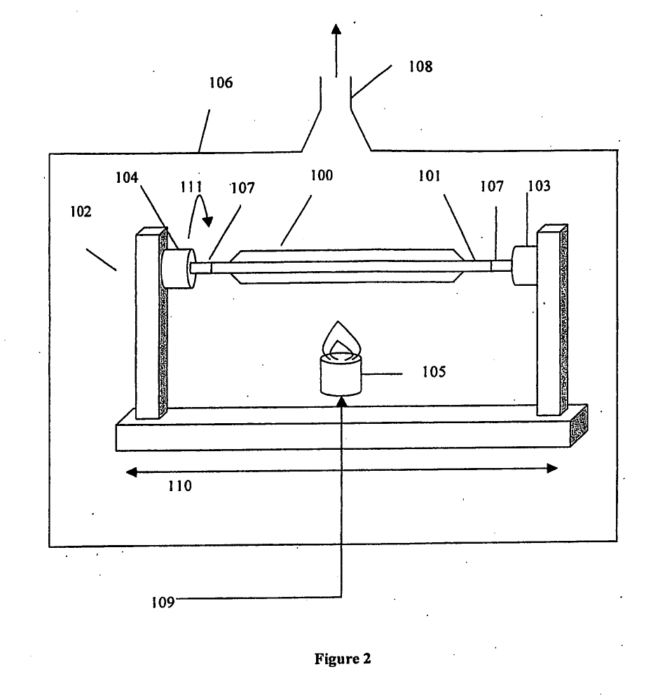

### DESCRIPTION AND PREFERRED EMBODIMENTS OF THE INVENTION

Before describing preferred embodiments of the present invention, definitions of various terminologies employed herein are provided merely for the ease of understanding which are not intended to limit scope of the present invention.

### DEFINITIONS

The refractive index profile is defined as the relation of the relative refractive index of a selected portion along the radii of the optical fiber preform or core rod or optical fiber as the case may be. An exemplary refractive index profile is shown in FIG. 4 wherein clad region 113 has lower refractive index n₂ than the refractive index n₁ of the core region 114. The exemplary refractive index profile illustrated in FIG. 4 can be attributed to optical fiber preform or core rod or optical fiber 112.

The relative refractive index A is defined as the ratio of refractive index n₁ of core 114 versus the refractive index n₂ of clad region 113 of the optical fiber preform or core rod or optical fiber 112, wherein

Δ=(n₁−n₂)/n₂ eqn (1)

The attenuation loss is the loss of power from input to output of the optical fiber. The attenuation loss of an optical fiber is usually measured in decibels (dB). If an input power P₁ results in an output power P₂, then the attenuation loss in decibels is given by:—

α=10 log₁₀(P₁/P₂) eqn (1.1)

The macrobending loss is loss of power due to radiation, increases exponentially with the radius of bending.

The cutoff wavelength of the fiber is the longest wavelength of light for which an optical fiber supports single mode.

λ_{c}=(2πa/2.4048)(n₁²−n₂²)^{0.5} eqn (2)

wherein a is the fiber core radius, and n₁ is refractive index of core 114 and n₂ is refractive index of clad 113 of the fiber 112.

In single mode optical fiber, it is the mode field diameter (MFD) rather than the core diameter that is an important parameter. The MFD essentially specifies the traverse path of the single mode fiber. For typical single mode fibers, the MFD extends far into the cladding region and, thus, the MFD of the fiber can be different and higher than that of the core diameter of the fiber.

The MAC number is the ratio of MFD versus cutoff wavelength of the fiber.

The radius of curvature R_{c} at which the bending loss increases sharply from negligible value to high values is defined as:—

R_{c}=20λΔ^{-3/2}(2.748−0.996λ/λ_{c})⁻³ eqn (4)

wherein λ is the operating wavelength, λ_{c} is the cutoff wavelength and Δ is relative refractive index of the fiber.

As described hereinabove, the increase in macrobending loss and increase in attenuation loss of the fiber produced by conventional method have been observed primarily due to its non-uniform refractive index, that is due to formation of slope in refractive index of outer region of the core region of the fiber and sudden dip in the refractive index of central region of the core region of the fiber which correspond to slope 116 in refractive index of outer regions of the core region of the optical fiber preform or core rod from which the fiber is drawn and sudden dip 117 in the refractive index of central region of the core region of the optical fiber preform or core rod from which fiber is drawn, thereby making the fiber unsuitable for access communication network application, that is fiber to the home [FTTH] applications.

The inventors of the present invention have observed that non-uniform refractive index of the core region, that is, formation of slope 116 in refractive index of outer region of the core region and formation of sudden dip 117 in the refractive index of central region of the core region of the optical fiber preform [or core rods or optical fiber] occurs during dehydration and sintering process steps, wherein germanium oxide particles diffuse from higher concentration side to lower concentration side, i.e. outer region germanium oxide particles diffuse towards the clad region thereby causing a slope in the refractive index of the outer region of the core, and similarly germanium oxide in the inner region diffuses into the capillary line thereby causing the sudden dip in the refractive index of the inner region of the core. In-addition during dehydration and sintering process step, chlorine has been observed to react with dopant, particularly with germanium oxide in the core of the hollow soot porous body thereby resulting in leaching of the dopant from the core.

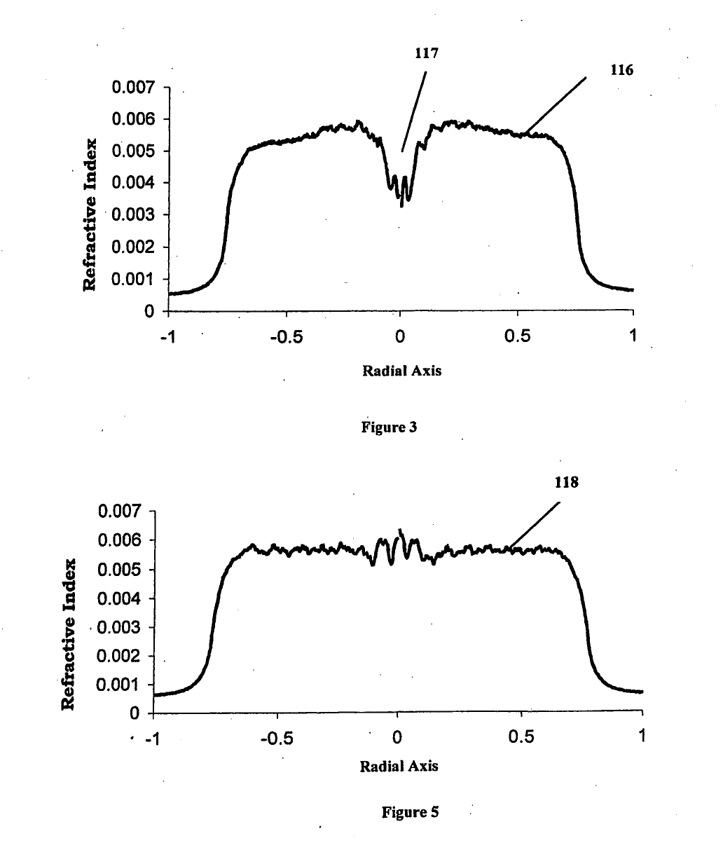

The diffusion of the dopant from the outer region of the core of the optical fiber preform or core rod into clad region has been observed to result in formation of a slope 116 that is non-uniform refractive index in outer region of the core region of the optical fiber preform or core rod. The diffusion of the dopant from the inner region of the core of the optical fiber preform or core rod into the capillary line has been observed to result in sudden dip 117 in the refractive index of the inner region of the core region of the optical fiber preform or core rod which also transmit in the fiber produced from such preform or core rods [FIG. 3], and hence, optical fiber drawn from such preform or core rods has also been observed to have non-uniform refractive index, that is, formation of slope 116 in outer region and formation of sudden dip 117 in inner region of core which has been found to be responsible for bending loss of about 0.15 dB/Km or even more at 1550 nm particularly when optical fiber is wound on a medium say of diameter of about 50 mm. Such optical fiber has been found to be unsuitable for shorter distance transmission because bending occurrence in shorter distance are higher, and hence, these fibers have been found to be unsuitable for access communication network applications, that is for fiber to the home [FTTH] applications.

The non-uniform refractive index, e.g. formation of slope 116 in refractive index of the outer region of the core and sudden dip 117 in the refractive index of the inner region of the core region of the optical fiber preform or core rods or fiber produced therefrom have been observed to result in increase in macrobending loss and attenuation loss in optical fiber produced which as described herein makes the fiber unsuitable for access communication network applications due to increased attenuation loss and macrobending loss.

It has been surprisingly observed by the inventors of the present invention that if formation of slope and sudden dip in refractive index profile of the core region of the optical fiber preform or core rods, and hence, of optical fiber produced therefrom can be minimized or eliminated then the fiber produced will have substantially uniform refractive index profile, and reduced macrobending loss and attenuation loss, and hence, will be suitable for access communication network applications, that is, for fiber to the home [FRTH] applications.

The inventors of present invention have surprisingly observed that formation of slope and sudden dip in refractive index profile of the core region of the optical fiber preform or core rods, and hence, of optical fiber produced therefrom can be minimized or eliminated by controlling concentration of dopant in the outer region and inner region of the core region with respect to middle region of the core region of the optical fiber preform or core rods, and hence, of optical fiber produced therefrom meaning thereby the preform or core rod or fiber produced therefrom will have uniform refractive index profile, and problems of macrobending loss and attenuation loss in drawn optical fiber will be minimized or at least substantially reduced.

The control of dopant concentration in inner and outer regions of core region in accordance with present invention has been found to have advantage of reducing adverse effects of diffusion of dopant particles from outer region of the core to clad region and from inner region of the core to capillary line of the optical fiber preform or core rods, and hence, of fiber produced therefrom, and therefore, substantially reducing problems of macrobending loss and attenuation loss in drawn optical fiber.

The inventors of present invention have also surprisingly observed that formation of slope and sudden dip in refractive index profile of the core region of the optical fiber preform or core rods, and hence, of optical fiber produced therefrom can be minimized or eliminated by controlling duration of dehydration process step during manufacture of optical fiber preform or core rods which has been found to have advantage of producing optical fiber preform or core rod or fiber produced therefrom having substantially uniform refractive index profile, and substantially reducing problems of macrobending loss and attenuation loss in drawn optical fiber.

The control of duration of dehydration process step has also been found to have advantage of reducing adverse effect of diffusion of dopant particles from outer region of the core to clad region and from inner region of the core to capillary line of the optical fiber preform or core rods, and hence of fiber produced therefrom, and therefore, substantially reducing problems of macrobending loss and attenuation loss in drawn optical fiber.

The inventors of present invention have also observed that non-uniformity in refractive index profile of the optical fiber preform or core rods or fiber produced therefrom occurs due to reaction of chlorine gas with dopant particles in the outer region and inner region of the core during dehydration and/or sintering process steps. Therefore, it has been surprisingly observed that if concentration of chlorine gas is reduced during dehydration and/or sintering process steps it has been found to have advantage of reducing non-uniformity of refractive index profile of preform or core rods, and hence of fiber produced therefrom, and substantially reducing problems of macrobending loss and attenuation loss in drawn optical fiber.

The inventors of present invention have also observed that if concentration of chlorine gas is controlled while controlling helium gas concentration, it also has been found to have advantage of reducing non-uniformity of refractive index profile of preform or core rods, and hence of fiber produced therefrom, and substantially reducing problems of macrobending loss and attenuation loss in drawn optical fiber.

Accordingly, the present invention relates to a method for manufacturing an optical fiber having uniform refractive index profile, and substantially reduced macrobending loss and attenuation loss characterized by controlling one or more of following parameters a), b) and/or c) during manufacturing optical fiber preform:—
a) controlling refractive index of outer region and inner region of the core region by controlling concentration of dopant in outer region and inner region of the core region with respect to middle region of the core region of the optical fiber preform;
b) controlling refractive index of outer region and inner region of the core region by controlling duration of dehydration process step;
c) controlling refractive index of outer region and inner region of the core region by controlling concentration of chlorine gas;
   which have been found to have advantage of producing optical fiber having uniform refractive index profile, and substantially reduced macrobending loss and attenuation loss.

In accordance with one of the preferred embodiments of the present invention, the method for manufacturing an optical fiber having uniform refractive index profile, and substantially reduced macrobending loss and attenuation loss is characterized by controlling refractive index of outer region and inner region of core region by controlling concentration of dopant in outer region and inner region of the core region with respect to middle region of the core region of the optical fiber preform which has been found to have advantage of producing optical fiber having uniform refractive index profile, and having substantially reduced macrobending loss and attenuation loss. In accordance with this embodiment, refractive index of outer region and inner region of the core region of the fiber is controlled by controlling concentration of dopant in outer region and inner region of the core region with respect to middle region of the core region of the optical fiber during production of preform.

In accordance with another preferred embodiment of the present invention, the method for manufacturing an optical fiber having uniform refractive index profile, and having substantially reduced macrobending loss and attenuation loss is characterized by controlling refractive index of outer region and inner region of the core region by controlling duration of dehydration process step during manufacture of the optical fiber preform which has been found to have advantage of producing optical fiber having uniform refractive index profile, and having substantially reduced macrobending loss and attenuation loss. In accordance with this embodiment, refractive index of outer region and inner region of the core region of the fiber is controlled by controlling duration of dehydration process step during production of preform.

In accordance with still another preferred embodiment of the present invention, the method for manufacturing an optical fiber having uniform refractive index profile, and having substantially reduced macrobending loss and attenuation loss is characterized by controlling refractive index of outer region and inner region of the core region by controlling concentration of chlorine gas during manufacture of the optical fiber preform which has been found to have advantage of producing optical fiber having uniform refractive index profile, and substantially reduced macrobending loss and attenuation loss. In accordance with this embodiment, refractive index of outer region and inner region of the core region of the fiber is controlled by controlling concentration of chlorine gas during production of preform.

In accordance with yet another preferred embodiment of the present invention, the method for manufacturing an optical fiber having uniform refractive index profile, and substantially reduced macrobending loss and attenuation loss is characterized by controlling following parameters during manufacturing optical fiber preform:—
a) controlling refractive index of outer region and inner region of core region by controlling concentration of dopant in outer region and inner region of core region with respect to middle region of the core region of the optical fiber preform;
b) controlling refractive index of outer region and inner region of core region by controlling duration of dehydration process step; and
c) controlling refractive index of outer region and inner region of core region by controlling concentration of chlorine gas;
   which have been found to have advantage of producing optical fiber having uniform refractive index profile, and substantially reduced macrobending loss and attenuation loss.

In accordance with preferred embodiment of the present invention, concentration of chlorine gas is controlled either during dehydration process step or sintering process step or dehydration and sintering process steps, preferably during dehydration process step because it has been found to have advantage of controlling concentration of chlorine gas at very initial stage.

In accordance with preferred embodiment of the present invention, concentration of chlorine gas is controlled while controlling concentration of the helium gas either during dehydration process step or sintering process step or dehydration and sintering process steps, preferably during dehydration process step because it has been found to have advantage of controlling concentration of chlorine gas at very initial stage.

In accordance with preferred embodiment of the present invention, concentration of dopant is controlled by carrying out the soot deposition step to deposit core of the optical fiber preform in a stepwise mode in order to achieve higher concentration of the dopant in inner deposition layers and in outer deposition layers than the concentration of the dopant in the middle deposition layers of the core region of the preform thereby resulting in core region having uniform refractive index profile in the outer region and inner region of the core region by controlling the concentration of dopant in outer region and inner region of the core region with respect to middle region of the core region of the optical fiber preform.

In accordance with the present invention, the concentration of the dopant in the inner deposition layers of the core and in outer deposition layers of the core is preferably maintained in the range varying from about 1.03 to about 1.14 times higher of the concentration of the dopant in the middle deposition layers of the core region of the optical fiber preform which has been found to have advantage of substantially reducing adverse effect of diffusion of dopant from outer and inner regions of core region of preform, and hence resulting in a core region having uniform refractive index in inner, middle and outer regions of the core region of preform or core rods, and hence of fiber produced from such preform or core rods.

In accordance with preferred embodiment of the present invention, the concentration of the dopant in the inner deposition layers of the core is preferably maintained in the range varying from about 1.03 to about 1.07 times higher of the concentration of the dopant in the middle deposition layers of the core region of the preform.

In accordance with another preferred embodiment of the present invention, the concentration of the dopant in the outer deposition layers of the core is preferably maintained in the range varying from about 1.10 to about 1.14 times higher of the concentration of the dopant in the middle deposition layers of the core region of the optical fiber preform.

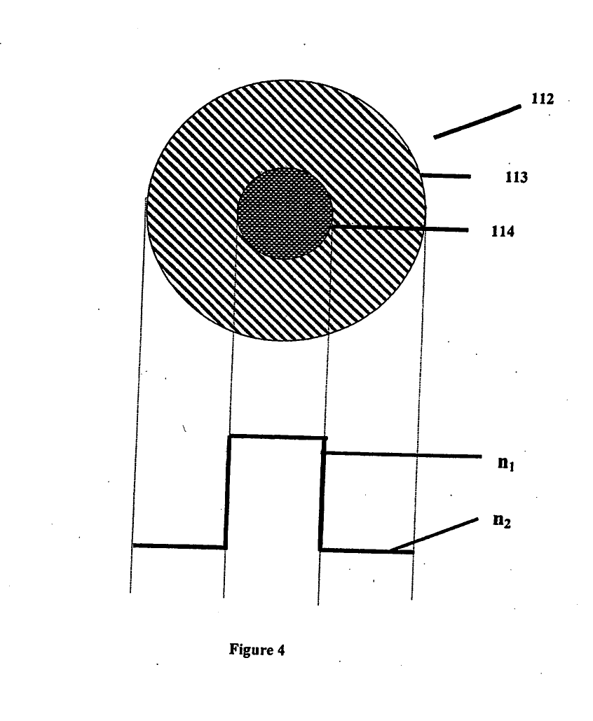

It has been surprisingly observed that above difference in dopant concentration in inner and outer regions of core region as compared to middle region thereof results in difference in refractive index of outer region and inner region of the core region with respect to middle region of the core region which has been found to have advantage of removing non-uniformity of the refractive index of the core region, that is, has been found to have advantage of avoiding formation of slope in refractive index of outer region of the core region and sudden dip in the refractive index of inner region of the core region of the optical fiber preform or core rods or fiber produced therefrom, and hence, the optical fiber preform or core rod produced in accordance with present invention, and optical fiber drawn from such optical fiber preform or core rods have been found to have refractive index profile as illustrated in accompanying FIG. 5, which as illustrated is substantially uniform.

In accordance with the present invention, the concentration of the dopant in the deposition process can be controlled or varied by controlling or varying the flow rate of the dopant base material, for example, varying flow rate of GeCl₄ vapor supply can vary the dopant GeO₂ concentration in the deposition process.

In accordance with one of the preferred embodiments of the present invention, the diameter or thickness of the inner deposition layers of the core region may vary from about 0.08 to about 0.15 times of the required core diameter or thickness. The diameter or thickness of the middle deposition layers of the core region may vary from about 0.4 to about 0.5 times of the required core diameter or thickness. The rest of the core diameter or thickness consists of outer deposition layers of the core region of the optical fiber preform.

In accordance with one of the preferred embodiments of the present invention, the duration of the dehydration process step is suitably controlled to achieve controlled exposure of outer region and inner region of the core region to chlorine gas which has also been found to have advantage of achieving core region having uniform refractive index.

In accordance with present invention, the preform is dehydrated for about 2.5 hrs to about 5 hrs duration. It has been surprisingly observed that if dehydration process step is carried out for said duration, the diffusion of dopant particles from the outer region of the core to clad region and from the inner region of the core to the capillary line of the preform is minimized thereby removes non-uniformity of the refractive index of the core region, that is, has been found to have advantage of avoiding formation of slope in refractive index of outer region of the core region and sudden dip in the refractive index of inner region of the core region of the optical fiber preform or core rods or fiber produced from such preform or core rods. The refractive index curve for core region of such optical fiber preform or core rod or fiber produced from such preform or core rod is the one as illustrated in accompanying FIG. 5, which as illustrated is substantially uniform.

It has been observed that if dehydration duration is reduced below 2.5 hrs limit, the dehydration does not get complete and optical fiber preform, and hence, optical fiber drawn therefrom will have undesired concentration of OH ions and will show water peak which has been found to result in high attenuation loss at about 1383 nm. If dehydration duration is increased above 5 hrs limit, the duration of exposure of the preform to chlorine gas increases which results in non-uniform refractive index of the core region, that is, formation of slope in refractive index of outer region and sudden dip in the refractive index of inner region of the core region of the optical fiber preform or core rod, and hence, in optical fiber drawn therefrom. The refractive index profile for core region of such optical fiber preform or core rod or fiber produced therefrom will the one as shown in FIG. 3. Accordingly, in accordance with present invention, the dehydration duration is preferably maintained between about 2.5 hrs to about 5 hrs including both values.

In accordance with present invention, the dehydration temperature during dehydration process step is preferably maintained in the range varying from about 900° C. to about 1200° C., preferably from about 1000° C. to about 1100° C., which has been found to have advantage of reducing non-uniformity of refractive index profile of the core region. It has been found that if dehydration temperature is above the 1200° C., it results in sintering of the soot body before completion of dehydration process step which in-turn results in undesired OH ion concentration, and hence, fiber produced has been found to show water peak, and therefore, has been found to be unsuitable for application in the wavelength range of about 1370 nm to about 1390 μm. It has also been found that if dehydration temperature is below 900° C., it results in increase in process time for complete removal of moisture content which has been found to result in wastage of time, and simultaneously the preform gets exposed to chlorine gas for more duration thereby renders the process useless to produce desired fiber. If the process time is reduced to save on time, and to avoid over-exposure of the preform to chlorine gas, the same has been found to result in preform having higher moisture concentration thereby the fiber produced has been found to show water peak, and therefore, has been found to be unsuitable for application in the wavelength range of about 1370 nm to about 1390 nm.

In accordance with one of the preferred embodiments of the present invention, the concentration of chlorine gas is controlled during dehydration process step in a manner suitable to have controlled exposure of outer region and inner region of the core region to chlorine gas which has been found to have advantage of resulting in core region having uniform refractive index. In accordance with present invention, concentration of chlorine gas is controlled by controlling its flow rate in the range varying from about 2 slpm [standard liters per minute] to about 1 slpm during dehydration process step. Controlling the concentration of chlorine in this range from about 2 slpm to about 1 slpm, that is reducing chlorine gas concentration during dehydration process step has been found to have surprising advantage of reducing leaching of the dopant from the core particularly the leaching of dopant in the core of the hollow soot porous body during the dehydration of the hollow soot porous body, and hence resulting in a core having uniform refractive index profile.

In accordance with one of the preferred embodiments of the present invention, the concentration of chlorine gas is controlled while controlling the concentration of the helium gas during dehydration process step in a manner suitable for resulting in controlled exposure of outer region and inner region of the core region to chlorine gas which has been found to result in core region having substantially uniform refractive index profile. The concentration of chlorine and helium gases is controlled by controlling their flow rates in a manner suitable to result in minimum ratio of concentration of chlorine gas to concentration of helium gas during dehydration process, which has been found to have advantage of resulting in reduced effective concentration of chlorine gas which has advantage of reducing leaching of dopant from core particularly leaching of dopant in core of hollow soot porous body during dehydration of hollow soot porous body, and hence resulting in a core having uniform refractive index profile.

In accordance with present invention, ratio of concentration of helium gas to concentration of chlorine gas during the dehydration process step is preferably maintained in the range varying from about 15 to about 25.

In accordance with one of the preferred embodiments of the present invention, the concentration of chlorine gas is controlled during dehydration process step as well as sintering process step in a manner suitable to have controlled exposure of outer region and inner region of core region to chlorine gas which has been found to have advantage of resulting in core region having substantially uniform refractive index profile. The concentration of chlorine gas is controlled by controlling its flow rate in a range varying from about 2 slpm to about 1 slpm for chlorine in the dehydration process step, and from about 1 slpm to 0 slpm in the sintering process step. It has been observed that during dehydration step 99% moisture is removed from the soot porous body, and hence, in accordance with present invention having higher but reducing concentration of chlorine during dehydration step and lower but reducing concentration of chlorine during sintering step has advantage of avoiding leaching of dopant from outer and inner regions of core region which otherwise would have caused slope and sudden dip in refractive profile of core region of preform.

Accordingly, in accordance with one embodiment of present invention, controlled exposure of inner and outer regions of core region to chlorine gas includes exposure of inner and outer regions of core region to reducing concentration of chlorine which is varied from a higher concentration to a lower concentration during dehydration and sintering process steps.

In accordance with present invention, concentration of helium gas is preferably maintained in a range varying from about 30 slpm to about 50 slpm.

In accordance with present invention dopant referred herein is preferably germanium oxide [GeO₂] dopant which is oxide formed from germanium tetrachloride [GeCl₄].

FIG. 5 illustrates refractive index profile of core region of the optical fiber preform or core rod produced in accordance with present invention or optical fiber produced from such preform or core rod produced in accordance with present invention and illustrates substantially uniform refractive index profile meaning thereby having no slope and sudden dip therein.

It may be noted that embodiments of present invention have been described with reference to manufacture of optical fiber from optical fiber preform, that is, from mother preform. However, present invention has been found to be suitably applicable when optical fiber is drawn from core rods drawn from optical fiber preform produced in accordance with present invention. Accordingly, in one embodiment of the present invention, the optical fiber is produced from core rods drawn from optical fiber preform produced in accordance with any one of the embodiments of the present invention.

The present invention is described with the help of following examples which are not intended to its limit scope.

In following examples, refractive index profile of the optical fiber preform or core rod was measured with profile analyzer PK 2600 and refractive index profile of optical fiber was measured with profile analyzer Photon Kinetics Model S14. The attenuation loss of the fiber was measured using OTDR commercially available from Photon Kinetics model number PK 6500, the cutoff wavelength and mode field diameter (MFD) were measured using module also commercially available from Photon Kinetics PK 2200. The macrobending loss due to bending was measured by bending test performed by bending or winding the fiber on a mandrel having diameter of 32 mm, 50 mm and 60 mm.

### Example 1

### Prior Art

An optical fiber preform was manufactured in accordance with conventional method by supplying SiCl₄ at a rate of 10.1 slpm and depositing initial soot with dopant chemical GeO₂ to increase refractive index of core region and terminating dopant GeO₂ after deposition of soot having 32 mm diameter. The dopant GeO₂ concentration was kept constant by keeping flow rate of GeCl₄ constant at 1.95 slpm throughout core deposition process. Thereafter, SiO₂ deposition was continued until soot porous body having 160 mm outer diameter (including both core and part of clad) was produced. The cylindrical member was detached to form hollow cylindrical soot porous body having a capillary therethrough, which was dehydrated for a duration of 260 min in a sintering furnace by heating to a temperature of 1050° C. in atmosphere of helium and chlorine gases with constant flow rates of 55 slpm and 2.5 slpm respectively to form dehydrated hollow soot porous body which was then sintered and simultaneously collapsed, while supplying chlorine and helium gas at a constant flow rate of 0.5 slpm and 55 slpm respectively to form sintered optical fiber preform (also known as mother preform) at a temperature of 1550° C. in 360 min. The sintered optical fiber preform was then drawn into 9 number of core rods having average diameter of 20.2 mm using a rod draw furnace. Two optical fibers were drawn one from preform and one from core rod. The optical fiber preform and core rods drawn therefrom and optical fibers drawn from preform and core rod were checked for refractive index profile which were found to be similar to one shown in accompanying FIG. 3, that is having a slope 116 in outer regions of core and a sudden dip 117 in central region of core. The macrobending loss and attenuation loss and other parameters of fiber produced were measured and are given in Table 1 which confirm that fiber produced by conventional method had increased macrobending loss and attenuation loss. The bending test performed confirmed increased loss from 0.345 dB/km to 0.442 dB/km after fiber was wounded onto mandrels of 32 mm, from 0.345 dB/km to 0.443 dB/km when wound on mandrel of 50 mm diameter and from 0.345 dB/km to 0.445 dB/km when wound on mandrel of 60 mm diameter respectively at wavelength of 1310 nm. Similar increase was also observed at other wavelengths of 1383 nm, 1550 nm and 1625 nm.

TABLE 1

| | Attenuation (dB/Km) | | | |
|---|---|---|---|---|
| | | Fiber winded on a mandrel | | |
| | | | 50 mm dia | 60 mm dia |
| | Without | 32 mm dia | with 100 | with 100 |
| Wavelength | mandrel | with 1 turn | turns | turns |
| 1310 nm | 0.345 | 0.442 | 0.443 | 0.445 |
| 1383 nm | 0.332 | 0.440 | 0.439 | 0.443 |
| 1550 nm | 0.205 | 0.345 | 0.349 | 0.352 |
| 1625 nm | 0.215 | 0.362 | 0.364 | 0.367 |

| | |
|---|---|
| MAC No. | 7.85 |
| Cutoff wavelength (nm) | 1195 |
| MFD (Micron) | 9.38 |

### Example 2

### Present Invention

An optical fiber preform was manufactured in accordance with method of present invention by supplying SiCl₄ at a rate of 10.1 slpm and depositing initial soot with dopant GeO₂ [oxide of GeCl₄] to increase refractive index of core region and terminating dopant after deposition of soot having 30 mm diameter.

The dopant concentration was controlled by controlling flow rate of GeCl₄, which was maintained at 2.32 slpm during deposition of inner layers of 3 mm thickness, at 2.21 slpm during deposition of middle layers of 13 mm thickness and at 2.47 slpm during deposition of outer layers. Thereafter, SiO₂ deposition was continued until soot porous body having 163 mm outer diameter (including both core and part of clad) was produced. The cylindrical member was detached to form hollow cylindrical soot porous body having a capillary therethrough, which was dehydrated for a duration of 260 min in a sintering furnace by heating to a temperature of 1050° C. in atmosphere of helium and chlorine gases with constant flow rates of 35 slpm and 1.85 slpm respectively to form dehydrated hollow soot porous body which was then sintered and simultaneously collapsed, while supplying chlorine and helium gas at a constant flow rate of 0.5 slpm and 40 slpm respectively to form sintered optical fiber preform (also known as mother preform) at a temperature of 1550° C. in 360 min. The sintered optical fiber preform was then drawn into 9 number of core rods having average diameter of 20.4 mm using a rod draw furnace. Two optical fibers were drawn one from preform and one from core rod. The optical fiber preform and core rods drawn therefrom and optical fibers drawn from preform and core rod were checked for refractive index profile which were found to be similar to one shown in accompanying FIG. 5 having substantially reduced slope in outer region of core and sudden dip in inner region of core meaning thereby having substantially uniform refractive index profile. The macrobending loss and attenuation loss and other parameters of fiber produced from core rod were measured and are given in Table 2 which confirm that fiber produced by present invention had reduced macrobending loss and attenuation loss. The bending test performed indicates slight increase in loss, but the same is comparatively very low, that is loss is increased from 0.335 dB/km to 0.380 dB/km after fiber was wounded onto mandrels of 32 mm, from 0.335 dB/km to 0.381 dB/km when wound on mandrel of 50 mm diameter and from 0.335 dB/km to 0.382 dB/km when wound on mandrel of 60 mm diameter at wavelength of 1310 nm. Similar increase, but very small increase was also observed at other wavelengths of 1383 nm, 1550 nm and 1625 nm.

TABLE 2

| | Attenuation (dB/Km) | | | |
|---|---|---|---|---|
| | | Fiber winded on a mandrel | | |
| | | | 50 mm dia | 60 mm dia |
| | Without | 32 mm dia | with 100 | with 100 |
| Wavelength | mandrel | with 1 turn | turns | turns |
| 1310 nm | 0.335 | 0.380 | 0.381 | 0.382 |
| 1383 nm | 0.320 | 0.360 | 0.357 | 0.359 |
| 1550 nm | 0.192 | 0.252 | 0.248 | 0.250 |
| 1625 nm | 0.205 | 0.255 | 0.248 | 0.247 |

| | |
|---|---|
| MAC No. | 7.75 |
| Cutoff wavelength (nm) | 1210 |
| MFD (Micron) | 9.38 |

### Example 3, 4 and 5

### Present Invention

Three optical fiber preforms were manufactured in accordance with present invention by employing method described in Example 2. However, this time refractive index profile was controlled by controlling duration of dehydration process step instead of controlling concentration of dopant which was kept constant. The dopant concentration was maintained by maintaining constant flow rate of GeCl₄ at 1.95 slpm during entire deposition process. The duration of dehydration process step was controlled at 160 min in example 3, at 180 min in example 4 and at 225 min in example 5.

The optical fibers drawn from core rod were checked for refractive index profile which were found to be similar to one shown in accompanying FIG. 5 having substantially reduced slope in outer region of core and sudden dip in inner region of core meaning thereby having substantially uniform refractive index profile. The macrobending loss and attenuation loss and other parameters of fibers produced were also measured and are given in Table 3 for fiber produced in example 3, in Table 4 for fiber produced in example 4 and in Table 5 for fiber produced in example 5, which confirm that fibers produced by these methods had reduced macrobending loss and attenuation loss. The bending test performed indicates slight increase in loss, but the same is comparatively very low, that is loss is increased from 0.332 dB/km to 0.360 dB/km after fiber was wounded onto mandrels of 32 mm, from 0.332 dB/km to 0.362 dB/km when wound on mandrel of 50 mm diameter and from 0.332 dB/km to 0.362 dB/km when wound on mandrel of 60 mm diameter at wavelength of 1310 nm in fiber of example 3. Similar increase, but very small increase was also observed at other wavelengths of 1383 nm, 1550 nm and 1625 nm.

TABLE 3

| | Attenuation (dB/Km) | | | |
|---|---|---|---|---|
| | | Fiber winded on a mandrel | | |
| | | | 50 mm dia | 60 mm dia |
| | Without | 32 mm dia | with 100 | with 100 |
| Wavelength | mandrel | with 1 turn | turns | turns |
| 1310 nm | 0.332 | 0.360 | 0.362 | 0.362 |
| 1383 nm | 0.322 | 0.354 | 0.357 | 0.360 |
| 1550 nm | 0.191 | 0.231 | 0.239 | 0.238 |
| 1625 nm | 0.206 | 0.254 | 0.255 | 0.256 |

| | |
|---|---|
| MAC No. | 7.69 |
| Cutoff wavelength (nm) | 1215 |
| MFD (Micron) | 9.34 |

TABLE 4

| | Attenuation (dB/Km) | | | |
|---|---|---|---|---|
| | | Fiber winded on a mandrel | | |
| | | | 50 mm dia | 60 mm dia |
| | Without | 32 mm dia | with 100 | with 100 |
| Wavelength | mandrel | with 1 turn | turns | turns |
| 1310 nm | 0.330 | 0.367 | 0.360 | 0.361 |
| 1383 nm | 0.318 | 0.350 | 0.353 | 0.355 |
| 1150 nm | 0.192 | 0.240 | 0.241 | 0.239 |
| 1625 nm | 0.205 | 0.255 | 0.254 | 0.257 |

| | |
|---|---|
| MAC No. | 7.75 |
| Cutoff wavelength (nm) | 1210 |
| MFD (Micron) | 9.38 |

TABLE 5

| | Attenuation (dB/Km) | | | |
|---|---|---|---|---|
| | | Fiber winded on a mandrel | | |
| | | | 50 mm dia | 60 mm dia |
| | Without | 32 mm dia | with 100 | with 100 |
| Wavelength | mandrel | with 1 turn | turns | turns |
| 1310 nm | 0.331 | 0.366 | 0.361 | 0.361 |
| 1383 nm | 0.320 | 0.352 | 0.355 | 0.357 |
| 1550 nm | 0.190 | 0.230 | 0.238 | 0.237 |
| 1625 nm | 0.201 | 0.249 | 0.250 | 0.251 |

| | |
|---|---|
| MAC No. | 7.68 |
| Cutoff wavelength (nm) | 1213 |
| MFD (Micron) | 9.32 |

### Example 6 to 8

### Present Invention

Three optical fiber preforms were manufactured in accordance with present invention by employing method described in Example 2. However, this time refractive index profile was controlled by controlling concentration of chlorine during dehydration process step. In these examples, the flow rate of chlorine was reduced from 1.85 slpm to 1.2 slpm. The remaining parameters, flow rates of SiCl₄, GeCl₄, chlorine during sintering process step, helium during dehydration process step, helium during sintering process step, and durations of dehydration step and sintering step, and temperature during dehydration and sintering steps were maintained at 10.1 slpm, 1.95 slpm, 0.5 slpm, 35 slpm, 40 slpm, 260 mins, 360 mins, 1050° C. and 1550° C. respectively. The core layer was deposited till achieving diameter of about 32 mm, the soot was continued to be deposited till achieving diameter of about 161 mm. 9 core rods having average diameter of about 20.1 mm were drawn from each preform produced in accordance with this embodiment. The drawn core rod, one from each example, was overcladded to have core rod having overclad of diameter of about 192 mm, which after sintering was subjected to fiber draw process to draw a fiber of length of about 380 Km.

The preform and core rods drawn therefrom and the optical fibers drawn from core rod was checked for refractive index profile which were found to be similar to one shown in accompanying FIG. 5 having substantially reduced slope in outer region of core and sudden dip in inner region of core meaning thereby having substantially uniform refractive index profile. The macrobending loss and attenuation loss and other parameters of fibers produced were also measured and are given in Tables 6, 7 and 8 for fiber drawn in examples 6, 7 and 8 respectively. The data in tables 6, 7 and 8 confirms that fibers produced by these examples had reduced macrobending loss and attenuation loss. The bending test performed also confirms greatly reduced bending loss on wounding the fiber onto mandrels of 32 mm, 50 mm and 60 mm diameters respectively.

TABLE 6

| | Attenuation (dB/Km) | | | |
|---|---|---|---|---|
| | | Fiber winded on a mandrel | | |
| | | | 50 mm dia | 60 mm dia |
| | Without | 32 mm dia | with 100 | with 100 |
| Wavelength | mandrel | with 1 turn | turns | turns |
| 1310 nm | 0.331 | 0.366 | 0.361 | 0.362 |
| 1383 nm | 0.315 | 0.347 | 0.350 | 0.352 |
| 1550 nm | 0.189 | 0.229 | 0.237 | 0.236 |
| 1625 nm | 0.200 | 0.248 | 0.249 | 0.250 |

| | |
|---|---|
| MAC No. | 7.65 |
| Cutoff wavelength (nm) | 1217 |
| MFD (Micron) | 9.31 |

TABLE 7

| | Attenuation (dB/Km) | | | |
|---|---|---|---|---|
| | | Fiber winded on a mandrel | | |
| | | | 50 mm dia | 60 mm dia |
| | Without | 32 mm dia | with 100 | with 100 |
| Wavelength | mandrel | with 1 turn | turns | turns |
| 1310 nm | 0.330 | 0.365 | 0.360 | 0.361 |
| 1383 nm | 0.319 | 0.351 | 0.354 | 0.356 |
| 1550 nm | 0.189 | 0.229 | 0.237 | 0.236 |
| 1625 nm | 0.209 | 0.257 | 0.258 | 0.259 |

| | |
|---|---|
| MAC No. | 7.61 |
| Cutoff wavelength (nm) | 1220 |
| MFD (Micron) | 9.29 |

TABLE 8

| | Attenuation (dB/Km) | | | |
|---|---|---|---|---|
| | | Fiber winded on a mandrel | | |
| | | | 50 mm dia | 60 mm dia |
| | Without | 32 mm dia | with 100 | with 100 |
| Wavelength | mandrel | with 1 turn | turns | turns |
| 1310 nm | 0.326 | 0.361 | 0.356 | 0.358 |
| 1383 nm | 0.316 | 0.348 | 0.351 | 0.353 |
| 1550 nm | 0.187 | 0.227 | 0.235 | 0.234 |
| 1625 nm | 0.208 | 0.256 | 0.257 | 0.258 |

| | |
|---|---|
| MAC No. | 7.63 |
| Cutoff wavelength (nm) | 1218 |
| MFD (Micron) | 9.30 |

### Example 9 to 11

### Present Invention

Three optical fiber preforms were manufactured in accordance with present invention by employing method described in Example 2. However, this time refractive index profile was controlled by controlling concentration of chlorine and helium during dehydration process step. In these examples, the flow rate of chlorine was reduced from 1.85 slpm to 1.2 slpm and flow rate of helium was varied from 30 slpm to 50 slpm. The remaining parameters, flow rates of SiCl₄, GeCl₄, chlorine during sintering process step, helium during sintering process step, and durations of dehydration step and sintering step, and temperature during dehydration and sintering steps were maintained at 10.1 slpm, 1.95 slpm, 0.5 slpm, 40 slpm, 260 mins, 360 mins, 1050° C. and 1550° C. respectively. The core layer was deposited till achieving diameter of about 31.5 mm, the soot was continued to be deposited till achieving diameter of about 162 mm. 9 core rods having average diameter of about 20.1 mm were drawn from each preform produced in accordance with this embodiment. The drawn core rod, one from each example, was overcladded to have core rod having overclad of diameter of about 192 mm, which after sintering was subjected to fiber draw process to draw a fiber of length of about 380 Km.

The preform and core rods drawn therefrom and the optical fibers drawn from core rod was checked for refractive index profile which were found to be similar to one shown in accompanying FIG. 5 having substantially reduced slope in outer region of core and sudden dip in inner region of core meaning thereby having substantially uniform refractive index profile. The macrobending loss and attenuation loss and other parameters of fibers produced were also measured and are given in Tables 9, 10 and 11 for examples 9, 10 and 11 respectively. The data in tables 9, 10 and 11 confirms that fibers produced by these methods also had reduced macrobending loss and attenuation loss. The bending test performed also confirms greatly reduced bending loss on wounding the fiber onto mandrels of 32 mm, 50 mm and 60 mm diameters respectively.

TABLE 9

| | Attenuation (dB/Km) | | | |
|---|---|---|---|---|
| | | Fiber winded on a mandrel | | |
| | | | 50 mm dia | 60 mm dia |
| | Without | 32 mm dia | with 100 | with 100 |
| Wavelength | mandrel | with 1 turn | turns | turns |
| 1310 nm | 0.328 | 0.363 | 0.358 | 0.359 |
| 1383 nm | 0.319 | 0.351 | 0.354 | 0.356 |
| 1550 nm | 0.188 | 0.228 | 0.236 | 0.232 |
| 1625 nm | 0.207 | 0.259 | 0.257 | 0.258 |

| | |
|---|---|
| MAC No. | 7.64 |
| Cutoff wavelength (nm) | 1215 |
| MFD (Micron) | 9.29 |

TABLE 10

| | Attenuation (dB/Km) | | | |
|---|---|---|---|---|
| | | Fiber winded on a mandrel | | |
| | | | 50 mm dia | 60 mm dia |
| | Without | 32 mm dia | with 100 | with 100 |
| Wavelength | mandrel | with 1 turn | turns | turns |
| 1310 nm | 0.330 | 0.362 | 0.359 | 0.360 |
| 1383 nm | 0.310 | 0.341 | 0.344 | 0.347 |
| 1550 nm | 0.186 | 0.225 | 0.234 | 0.233 |
| 1625 nm | 0.206 | 0.253 | 0.258 | 0.256 |

| | |
|---|---|
| MAC No. | 7.64 |
| Cutoff wavelength (nm) | 1210 |
| MFD (Micron) | 9.25 |

TABLE 11

| | Attenuation (dB/Km) | | | |
|---|---|---|---|---|
| | | Fiber winded on a mandrel | | |
| | | | 50 mm dia | 60 mm dia |
| | Without | 32 mm dia | with 100 | with 100 |
| Wavelength | mandrel | with 1 turn | turns | turns |
| 1310 nm | 0.329 | 0.364 | 0.361 | 0.362 |
| 1383 nm | 0.314 | 0.346 | 0.349 | 0.351 |
| 1550 nm | 0.189 | 0.229 | 0.237 | 0.236 |
| 1625 nm | 0.204 | 0.252 | 0.253 | 0.254 |

| | |
|---|---|
| MAC No. | 7.66 |
| Cutoff wavelength (nm) | 1208 |
| MFD (Micron) | 9.26 |

### Example 12 to 14

### Present Invention

Three optical fiber preforms were manufactured in accordance with present invention by employing method described in Example 2. However, this time refractive index profile was controlled by controlling concentration of chlorine during dehydration as well as sintering process steps. In these examples, the flow rate of chlorine was reduced from 1.85 slpm to 1.2 slpm during dehydration step and from 1 slpm to 0 slpm during sintering step. The remaining parameters, flow rates of SiCl₄, GeCl₄, helium during dehydration step, helium during sintering process step, and durations of dehydration step and sintering step, and temperature during dehydration and sintering steps were maintained at 10.1 slpm, 1.95 slpm, 35 slpm, 40 slpm, 260 mins, 360 mins, 1050° C. and 1550° C. respectively. The remaining parameters were maintained as in examples 9 to 11. 9 core rods having average diameter of about 20.1 mm were drawn from each preform produced in accordance with this embodiment. The drawn core rod, one from each example, was overcladded to have core rod having overclad of diameter of about 192 mm, which after sintering was subjected to fiber draw process to draw a fiber of length of about 380 Km.

The preform and core rods drawn therefrom and the optical fibers drawn from core rod was checked for refractive index profile which were found to be similar to one shown in accompanying FIG. 5 having substantially reduced slope in outer region of core and sudden dip in inner region of core meaning thereby having substantially uniform refractive index profile. The macrobending loss and attenuation loss and other parameters of fibers produced were also measured and are given in Tables 12, 13 and 14 for examples 12, 13 and 14 respectively. The data in tables 12, 13 and 14 confirms that fibers produced by these methods also had reduced macrobending loss and attenuation loss. The bending test performed also confirms greatly reduced bending loss on wounding the fiber onto mandrels of 32 mm, 50 mm and 60 mm diameters respectively.

TABLE 12

| | Attenuation (dB/Km) | | | |
|---|---|---|---|---|
| | | Fiber winded on a mandrel | | |
| | | | 50 mm dia | 60 mm dia |
| | Without | 32 mm dia | with 100 | with 100 |
| Wavelength | mandrel | with 1 turn | turns | turns |
| 1310 nm | 0.330 | 0.366 | 0.367 | 0.368 |
| 1383 nm | 0.326 | 0.359 | 0.361 | 0.363 |
| 1550 nm | 0.187 | 0.225 | 0.235 | 0.237 |
| 1625 nm | 0.208 | 0.254 | 0.257 | 0.258 |

| | |
|---|---|
| MAC No. | 7.69 |
| Cutoff wavelength (nm) | 1205 |
| MFD (Micron) | 9.27 |

TABLE 13

| | Attenuation (dB/Km) | | | |
|---|---|---|---|---|
| | | Fiber winded on a mandrel | | |
| | | | 50 mm dia | 60 mm dia |
| | Without | 32 mm dia | with 100 | with 100 |
| Wavelength | mandrel | with 1 turn | turns | turns |
| 1310 nm | 0.321 | 0.356 | 0.357 | 0.357 |
| 1383 nm | 0.310 | 0.342 | 0.345 | 0.347 |
| 1550 nm | 0.187 | 0.227 | 0.235 | 0.234 |
| 1625 nm | 0.202 | 0.250 | 0.251 | 0.252 |

| | |
|---|---|
| MAC No. | 7.57 |
| Cutoff wavelength (nm) | 1221 |
| MFD (Micron) | 9.25 |

TABLE 14

| | Attenuation (dB/Km) | | | |
|---|---|---|---|---|
| | | Fiber winded on a mandrel | | |
| | | | 50 mm dia | 60 mm dia |
| | Without | 32 mm dia | with 100 | with 100 |
| Wavelength | mandrel | with 1 turn | turns | turns |
| 1310 nm | 0.326 | 0.361 | 0.358 | 0.359 |
| 1383 nm | 0.316 | 0.348 | 0.351 | 0.353 |
| 1550 nm | 0.188 | 0.228 | 0.236 | 0.235 |
| 1625 nm | 0.204 | 0.252 | 0.253 | 0.254 |

| | |
|---|---|
| MAC No. | 7.55 |
| Cutoff wavelength (nm) | 1220 |
| MFD (Micron) | 9.22 |

### Example 15 to 17

### Present Invention

Three optical fiber preforms were manufactured in accordance with present invention by employing method described in Example 2. However, this time refractive index profile was controlled by controlling concentration of chlorine during dehydration and duration of dehydration step. In these examples, the flow rate of chlorine was reduced from 1.85 slpm to 1.2 slpm during dehydration step and duration of dehydration step was maintained at 160 min in example 15, at 180 min in example 16 and at 220 min in example 17. The remaining parameters, flow rates of SiCl₄, GeCl₄, chlorine during dehydration step, helium during dehydration step, helium during sintering process step, and duration of sintering step, and temperature during dehydration and sintering steps were maintained at 10.1 slpm, 1.95 slpm, 0.5 slpm, 35 slpm, 40 slpm, 360 mins, 1050° C. and 1550° C. respectively. The remaining parameters were maintained as in examples 9 to 11. 9 core rods having average diameter of about 20.1 mm were drawn from each preform produced in accordance with this embodiment. The drawn core rod, one from each example, was overcladded to have core rod having overclad of diameter of about 192 mm, which after sintering was subjected to fiber draw process to draw a fiber of length of about 380 Km.

The preform and core rods drawn therefrom and the optical fibers drawn from core rod was checked for refractive index profile which were found to be similar to one shown in accompanying FIG. 5 having substantially reduced slope in outer region of core and sudden dip in inner region of core meaning thereby having substantially uniform refractive index profile. The macrobending loss and attenuation loss and other parameters of fibers produced were also measured and are given in Tables 15, 16 and 17 for examples 15, 16 and 17 respectively. The data in tables 15, 16, 17 confirms that fibers produced by these methods also had reduced macrobending loss and attenuation loss. The bending test performed also confirms greatly reduced bending loss on wounding the fiber onto mandrels of 32 mm, 50 mm and 60 mm diameters respectively.

TABLE 15

| | Attenuation (dB/Km) | | | |
|---|---|---|---|---|
| | | Fiber winded on a mandrel | | |
| | | | 50 mm dia | 60 mm dia |
| | Without | 32 mm dia | with 100 | with 100 |
| Wavelength | mandrel | with 1 turn | turns | turns |
| 1310 nm | 0.324 | 0.331 | 0.332 | 0.333 |
| 1383 nm | 0.300 | 0.332 | 0.335 | 0.337 |
| 1550 nm | 0.187 | 0.207 | 0.212 | 0.216 |
| 1625 nm | 0.202 | 0.232 | 0.235 | 0.236 |

| | |
|---|---|
| MAC No. | 7.53 |
| Cutoff wavelength (nm) | 1225 |
| MFD (Micron) | 9.23 |

TABLE 16

| | Attenuation (dB/Km) | | | |
|---|---|---|---|---|
| | | Fiber winded on a mandrel | | |
| | | | 50 mm dia | 60 mm dia |
| | Without | 32 mm dia | with 100 | with 100 |
| Wavelength | mandrel | with 1 turn | turns | turns |
| 1310 nm | 0.326 | 0.346 | 0.344 | 0.345 |
| 1383 nm | 0.302 | 0.327 | 0.328 | 0.329 |
| 1550 nm | 0.187 | 0.207 | 0.212 | 0.216 |
| 1625 nm | 0.203 | 0.224 | 0.225 | 0.227 |

| | |
|---|---|
| MAC No. | 7.56 |
| Cutoff wavelength (nm) | 1225 |
| MFD (Micron) | 9.27 |

TABLE 17

| | Attenuation (dB/Km) | | | |
|---|---|---|---|---|
| | | Fiber winded on a mandrel | | |
| | | | 50 mm dia | 60 mm dia |
| | Without | 32 mm dia | with 100 | with 100 |
| Wavelength | mandrel | with 1 turn | turns | turns |
| 1310 nm | 0.325 | 0.345 | 0.343 | 0.344 |
| 1383 nm | 0.301 | 0.326 | 0.328 | 0.328 |
| 1550 nm | 0.189 | 0.209 | 0.210 | 0.215 |
| 1625 nm | 0.204 | 0.225 | 0.225 | 0.228 |

| | |
|---|---|
| MAC No. | 7.58 |
| Cutoff wavelength (nm) | 1223 |
| MFD (Micron) | 9.28 |

The present method has been observed to be suitable for a preform even if cladding region is provided with overclad region.

It may be noted that present method has been described for ACVD method. However, it is suitable even for all other known methods for manufacturing optical fiber preforms.

It may also be noted that merely for ease of understanding the core region of the preform or core rod or fiber as the case may be has been divided into three regions, that is inner region towards capillary/centerline of the preform or core rod or fiber, outer region towards clad region of the preform or core rod or fiber and middle region in-between said inner and outer regions.

These terms are not intended to limit scope or interpretation of present invention.

The optical fiber produced in accordance with present invention has been found to have uniform refractive index of the core having cutoff wavelength greater than about 1200 nm, mode field diameter of less than about 9.4 μm and MAC number less than about 7.8.

The optical fiber produced in accordance with present invention has been found to have bending loss of less than about 0.05 dB/Km at about 1550 nm when optical fiber is wound 1 turn on mandrel of about 32 mm diameter, and about 0.05 dB/Km at about 1550 nm when optical fiber is wound about 100 turn on mandrel of about 50 mm diameter, and less than about 0.05 dB/Km at about 1625 nm when optical fiber is wound about 100 turn on mandrel of about 60 mm diameter.

The optical fiber produced in accordance with present invention has been found to have reduced bending loss, wherein optical attenuation loss is less than about 0.34 dB/Km at 1310 nm, 0.19 dB/Km at 1550 nm and 0.30 dB/Km at wavelength 1383 nm.

The optical fiber produced in accordance with present invention has been found to have other characteristics within the desired limits thereof, that is, clad diameter of about 125 μm, cutoff wavelength greater than about 1200 nm, preferably varying from about 1200 nm to about 1300 nm, mode field diameter of less than about 9.4 μm, preferably varying from about 9.0 to about 9.4 μm and MAC number less than about 7.8.

1. A method for manufacturing an optical fiber having uniform refractive index profile, and substantially reduced macrobending loss and attenuation loss characterized by controlling one or more of following parameters a), b) and/or c) during manufacturing optical fiber preform:—
a) controlling refractive index of outer region and inner region of the core region by controlling concentration of dopant in outer region and inner region of the core region with respect to middle region of the core region of the optical fiber preform;
b) controlling refractive index of outer region and inner region of the core region by controlling duration of dehydration process step;
c) controlling refractive index of outer region and inner region of the core region by controlling concentration of chlorine gas;
which have been found to have advantage of producing optical fiber having uniform refractive index profile, and substantially reduced macrobending loss and attenuation loss.

2. A method as claimed in claim 1, wherein refractive index of outer region and inner region of core region is controlled by controlling concentration of dopant in outer region and inner region of core region with respect to middle region of core region of optical fiber preform.

3. A method as claimed in claim 1, wherein refractive index of outer region and inner region of core region is controlled by controlling duration of dehydration process step.

4. A method as claimed claim 1, wherein refractive index of outer region and inner region of core region is controlled by controlling concentration of chlorine gas.

5. A method for manufacturing an optical fiber having uniform refractive index profile, and substantially reduced macrobending loss and attenuation loss is characterized by controlling following parameters during manufacturing optical fiber preform:—
a) controlling refractive index of outer region and inner region of core region by controlling concentration of dopant in outer region and inner region of core region with respect to middle region of the core region of the optical fiber preform;
b) controlling refractive index of outer region and inner region of core region by controlling duration of dehydration process step; and
c) controlling refractive index of outer region and inner region of core region by controlling concentration of chlorine gas;
which have been found to have advantage of producing optical fiber having uniform refractive index profile, and substantially reduced macrobending loss and attenuation loss.

6. A method as claimed in claim 1, wherein concentration of chlorine gas is controlled either during dehydration process step or sintering process step or dehydration and sintering process steps, preferably during dehydration process step to have advantage of controlling concentration of chlorine gas at very initial stage.

7. A method as claimed in claim 6, wherein concentration of chlorine gas is controlled while controlling concentration of the helium gas.

8. A method as claimed in claim 1, wherein concentration of dopant is controlled by carrying out soot deposition step in stepwise mode in a manner to achieve higher concentration of dopant in inner deposition layers and in outer deposition layers than in middle deposition layers to form core region having uniform refractive index.

9. A method as claimed in claim 8, wherein concentration of dopant in inner deposition layers and in outer deposition layers is preferably maintained in a range varying from about 1.03 to about 1.14 times higher of concentration of dopant in middle deposition layers of optical fiber preform.

10. A method as claimed in claim 9, wherein concentration of dopant in inner deposition layers of core is preferably maintained in range varying from about 1.03 to about 1.07 times higher of concentration of dopant in middle deposition layers of preform.

11. A method as claimed in claim 9, wherein concentration of dopant in outer deposition layers of core is preferably maintained in a range varying from about 1.10 to about 1.14 times higher of concentration of dopant in middle deposition layers of core region of preform.

12. A method as claimed in claim 1, wherein diameter of inner deposition layers of core region is varied from about 0.08 to about 0.15 times of required core diameter.

13. A method as claimed in claim 1, wherein diameter of middle deposition layers of core region is varied from about 0.4 to about 0.5 times of required core diameter.

14. A method as claimed in claim 1, wherein duration of dehydration process step is suitably controlled to achieve controlled exposure of outer region and inner region of core region to chlorine gas.

15. A method as claimed in claim 1, wherein preform is dehydrated for about 2.5 hrs to about 5 hrs duration.

16. A method as claimed in claim 1, wherein dehydration temperature during dehydration process step is preferably maintained in a range varying from about 900° C. to about 1200° C., preferably from about 1000° C. to about 1100° C.

17. A method as claimed in claim 6, wherein concentration of chlorine gas is controlled during dehydration process step in a manner suitable to have controlled exposure of outer region and inner region of core region to chlorine gas.

18. A method as claimed in claim 17, wherein concentration of chlorine gas is controlled by controlling its flow rate in a range varying from about 2 slpm to about 1 slpm.

19. A method as claimed in claim 7, wherein concentration of chlorine gas is controlled while controlling concentration of helium gas during dehydration process step in a manner suitable for resulting in controlled exposure of outer region and inner region of core region to chlorine gas.

20. A method as claimed in claim 19, wherein ratio of concentration of helium gas to concentration of chlorine gas during dehydration process step is maintained in a range varying from about 15 to about 25.

21. A method as claimed in claim 7, wherein concentration of chlorine gas is controlled by controlling its flow rate in a range varying from about 1 slpm to 0 slpm in sintering process step.

22. A method as claimed in claim 1, wherein controlled exposure of inner and outer regions of core region to chlorine gas includes exposure of inner and outer regions of core region to reducing concentration of chlorine which is varied from a higher concentration to a lower concentration during dehydration and sintering process steps.

23. A method as claimed in claim 1, wherein concentration of helium gas is preferably maintained in a range varying from about 30 slpm to about 50 slpm.

24. A method as claimed in claim 1, wherein dopant is preferably oxide of germanium tetrachloride.

25. A method as claimed in claim 1, wherein preform produced is drawn to core rods having reduced diameters before drawing into optical fiber.

26. An optical fiber preform having uniform refractive index as and when produced by method as claimed in claim 1.

27. An optical fiber having uniform refractive index and substantially reduced macrobending loss and attenuation loss as and when produced by method as claimed in claim 1.

28. An optical fiber as claimed in claim 27 having cutoff wavelength greater than about 1200 nm, mode field diameter of less than about 9.4 μm and MAC number less than about 7.8.

29. An optical fiber as claimed in claim 27 having bending loss of less than about 0.05 dB at about 1550 nm when optical fiber is wound 1 turn on mandrel of about 32 mm diameter, less than about 0.05 dB at about 1550 nm when optical fiber is wound about 100 turn on mandrel of about 50 mm diameter, and less than about 0.05 dB at about 1625 nm when optical fiber is wound about 100 turn on mandrel of about 60 mm diameter.

30. An optical fiber as claimed claim 29 having attenuation loss less than about 0.34 dB/Km at 1310 nm, 0.19 dB/Km at 1550 nm and 0.30 dB/Km at wavelength 1383 nm.

31. An optical fiber as claimed in claim 27 having clad diameter of about 125 μm, cutoff wavelength preferably varying from about 1200 nm to about 1300 nm, mode field diameter preferably varying from about 9.0 to about 9.4 μm.

32. (canceled)

33. (canceled)

34. An optical fiber having uniform refractive index and substantially reduced macrobending loss and attenuation loss as and when produced by method as claimed in claim 5.

35. An optical fiber having uniform refractive index and substantially reduced macrobending loss and attenuation loss as and when produced from core rod as produced by method as claimed in claim 25.

36. An optical fiber having uniform refractive index and substantially reduced macrobending loss and attenuation loss as and when produced from preform as claimed in claim 26.

37. An optical fiber preform having uniform refractive index as and when produced by method as claimed in claim 5.
